(19) United States
(12) Patent Application Publication
(10) Pub. No.: US 2004/0071842 A1
(43) Pub. Date: Apr. 15, 2004

(54) Method for high-pressure preservation

(76) Inventors: Ludo Jean Marie Mathilde Van Schepdael, Herent (BE); Wouter Bernardus Cornelius De Heij, Lelystad (NL); Hans Hoogland, Maassluis (NL)

Correspondence Address: YOUNG & THOMPSON, 745 SOUTH 23RD STREET 2ND FLOOR, ARLINGTON, VA, 22202

(21) Appl. No.: 10/433,418

(22) PCT Filed: Dec. 4, 2001
(86) PCT No.: PCT/NL01/00882

(30) Foreign Application Priority Data
Dec. 4, 2000 (EP) 00204332.1
Feb. 6, 2001 (EP) 01200435.4

(51) Int. Cl. A23L 1/31

(52) U.S. Cl. 426/281

(57) ABSTRACT

The invention relates to a method for treatment of a product, in particular preservation of a food product or pharmaceutical product, by use or high pressure. The invention is characterized in that the high pressure process is carried out under such conditions that leakage of heat from the product to the surrounding material is minimized or even prevented. In one embodiment the product is pressurized to at least 100 MPa at a pressure is at least 5 MPa·s⁻¹. In one embodiment the vessel wall has a heat conductivity no higher than 25 W·m⁻¹·K⁻¹, preferably not higher than 10 W·m⁻¹·K⁻¹, more preferably not higher that 1 W·m⁻¹·K⁻¹ . In another embodiment a liner is used having an adiabatic temperature rise of between 1 and 10 K per 100 MPa, preferably between 2 and 7 K per MPa.

### FIELD OF THE INVENTION

The invention relates to a method of high pressure treatment of a product, in particular preservation of a food product or treatment of a pharmaceutical product, in a pressure vessel, and to an apparatus for out the method.

### BACKGROUND OF THE INVENTION

The adiabatic-temperature-rise, which occurs when a product is pressurized hydrostatically, coupled with the lethal effect of the pressure on micro-organisms, is known to have a preservative effect. In most High Pressure Processing (HPP) systems, heat transfer occurs from the product at increased product temperature to the HPP vessel wall, resulting in a decreasing temperature of the product fraction especially near the HPP vessel wall. Hence, the heat is transferred from the product to the vessel, leading to a temperature decrease of the product near the vessel.

Extending the shelf life of food products and other products sensitive to microbial spoilage, hence sterilization or inactivation of microorganisms, microbial spores and enzymes, is being performed by relatively slow heating process retorts, with a slow cooling of the food. The combination of high temperature and long residence times, results in a decreasing quality of the food. Flavors are reduced, texture changes resulting in undesired changes in mouthfeeling (often mushy and soft) and the color mostly becomes darker or gray. Most of these negative effects are the result of high temperature chemical reactions, e.g. Maillard reactions. Even when fast-heating systems are being used, e.g. microwave systems, these negative effects are not being cancelled because rapid or homogeneous cooling systems do not exist for batch processing.

The last decades a lot of research has been performed to invent preservation systems leading to minimal thermal damage. Examples of these novel technologies are pulsed electric field (PEF) and High Pressure Processing (HPP). Both being mild processes and with known pasteurization effects, the search of sterilization conditions or process conditions is still a matter of research. Several researchers proved that the sterilization effects are a result of the combination of heat and pressure. The application of multiple (>6) consecutive pressure pulses, or long pressure holding time (>30 min.), have been proven to result in a ‘sterile’ product (Hayakawa, Journal of food science Vol. 59, No 1, 1994). The word sterile is being placed between quotes use the sterility effect is often extrapolated from less lethal conditions (e.g. if an experiment with 20 min. holding time results in a 6 D reduction, it is extrapolated to a 12 D reduction at 40 min. holding time). Both methods have no commercial value. The cycle times are too long to apply these conditions cost effectively in food industry.

U.S. Pat. No. 6,017,572 (Meyer) describes a sterilization process consisting of at least two pressure pulses, with an initial-product-temperature of at least 70° C. Furthermore, the proposes several other conditions that can be used to sterilize food. Examples of process conditions which may provide sterility are T₀=70° C./p=1000 MPa, or T₀=90° C. /p=700 MPa.

U.S. Pat. No. 6.086.936 (Wilson) discloses pressure sterilization of food by applying a single high-pressure pulse, combined with a high initial-product-temperature. This method leverages the product-temperature-rise that occurs when the food is pressurized hydrostatically, coupled with the lethality of pressure, to achieve the appropriate sterilization conditions. This patent varies to the Meyer patent not only because it utilizes only one pressure pulse, but also in the fact that higher initial-product-temperatures are needed. Sterility of a spore suspension is obtained only if approximately 100° C. initial-product-temperature is combined with a pressure treatment of approximately 700 MPa The benefit of this patent above Meyer is the fact that a one-pulse pressure treatment cam be commercially more interesting than applying two or more pressure pulses. Wilson specifically mentions that the effects obtained are the result of both the pressure and the final-product-temperature reached due to the pressure treatment.

U.S. Pat. No. 6,033,701 (Hirsch) describes a sterilization method also applying high-pressures. In this invention, however, only one, relatively low, pressure pulse is subjected to the foodstuff. Food sterility or the increase of shelf life of food is obtained by applying long treatment times, Hirsch states that food, food ingredients and cooked foods are preserved by the application of pressure of at least 70 MPa for more than twelve hours. For some fruits and vegetables, the ripening could be stopped by the pressure treatment, while other fruits and vegetables are preserved by a five-day pressure treatment at 175 MPa. Because no heat is used, much of the firmness and texture is retained with this mild pressure treatment. In an example Hirsch shows the successful preservation of milk for 36 days at 70 MPa (10 ksi); the proposes the milk to be stored by dairymen, transported from dairies and stored prior to distribution without the need of refrigeration. Tankers could be constructed in such a way that partial loads could be carried.

Meyer proposed a sterilisation process with the combination of high initial temperature, high-pressure and two or more pressure pulses. Wilson applied only one high-pressure pulse combined with, compared with Meyer, higher initial temperatures. Hirsch claims food preservation by the application of pressure of at least 70 MPa for more than twelve hours.

Other high-pressure methods are described in U.S. Pat. No. 5,316,745, U.S. Pat. No. 5,288,462 and U.S. Pat. No. 5,228,394. Most patents disclose a high-pressure sterilization method for a specific product, but do not claim a technology based hydrostatic preservation method.

A typical time to obtain working process pressure of 700 MPa in industrial HPP applications is 3-10 minutes, resulting in a pressurization rate of 3.9-1.1 MPa·s⁻¹.

An analysis of current HPP equipment shows that when one starts with vessel and product at the same temperature, cooling of product especially near the vessel wall always occurs during pressurization and treatment in conventional HPP systems. The product fraction near the wall has a temperature between the temperature of the wall of the vessel and the final-product-temperature in the center of the vessel. Although HPP acts instantaneously and uniformly, due to geometrical factors and material properties (heat losses) a non-uniform temperature distribution will be obtained. The total degree of inactivation is therefore determined by the fraction that is subjected to the lowest intensity of treatment, hence the fraction with the lowest temperature while pressurized. This leads to the following conclusion:

Since the degree of sterilization/pasteurization is determined by the food fraction with the lowest final-product-temperature, this lowest final-product-temperature determines the lowest sterilization/pasteurization conditions in combination with pressure. Hence, effectiveness of the process is determined by both the lowest final-product-temperature in the vessel and the pressure.

However, if the conclusion above is related to current HPP practice, the authors surprisingly noticed that a lot of experimental work published in literature is performed under non-ideal conditions. For instance, the temperature sensor in common systems is placed in the center of the vessel, hence the hottest spot in an HPP-system, whereas the lowest final-product-temperature is observed near the wall of the HPP vessel. To quote a recent FDA report (US Food and Drug Administration, Center for Food Safety and Applied Nutrition, Kinetics of Microbial Inactivation for Alternative Food Processing Technologies, IFT/FDA Contract No. 223-98-2333, 2 Jun. 2000): “The use of elevated temperatures as part of a specified HPP process will require monitoring the food temperature during the process to ensure every element of the food is at or above the specified temperature”.

In an other part of this FDA report, a warning towards researchers is given: “For this reason care must be taken in keeping a food sample at constant temperature during pressure treatment or determining the temperature of the food during compression and decompression. Most food researchers working on pressure treatment of foods do not control the temperature during pressure treatment. Temperature control would be necessary to obtain meaningful microbial or enzymatic inactivation kinetics.”

The temperature distribution in typical HPP systems is given in FIG. 1. A method to reduce heat leakage is the application of packaging systems that avoid wall contact. These solutions however are not totally effective in systems with a long pressurization time or pressure holding time. Since the effect of non-homogeneous temperature distribution is also (partially) recognized by HPP manufactures, active heating systems are available on the market. These systems consist of a product temperature sensor inside the HPP vessel, a heating coil inside the vessel and controls. The major drawbacks of these systems are the robustness and the validation of this critical process factor. Furthermore these solutions to control the product temperature are subjected to another major drawback: these methods need vessel space and are economically not favorable. Since cost effectiveness of HPP is strongly related with the filling grade of the HPP-vessel, these solutions are therefore non favorable.

The effect of non-uniform temperature distribution is of less importance for a process with a relatively long HPP cycle time (e.g. 10-60 minutes or longer), and for processes in which only the pressure cycle is used for the aimed effect and no synergetic effect of the product-temperature-rise and pressure is essential (e.g. HPP pasteurization at ambient temperature). Due to the search for process conditions for operating at lowest processing costs, hence a decreased cycle time (and maximum throughput per unit of time), use of this synergy becomes more and more important.

With this invention the authors therefore focus on how obtain and maintain products to a homogeneous temperature distribution when imposed to a pressure treatment, in order to reach a product-temperature-rise that is almost equal to the adiabatic-temperature-rise, and therefore to be able to apply the mildest food preservation process conditions possible. These mildest preservation conditions are significantly lower than currently reported process conditions.

It is therefore an objective of the invention to overcome the difficulties in the prior art.

It is another objective of the present invention to provide a method for treating a product, in particular foodstuff and other spoilable products to enlarge the shelf life using high pressure.

It is a further objective of the present invention to provide a method in which homogeneous temperature conditions can be obtained while processing product, such as food with high pressure. These homogeneous conditions are obtained by the combination of technical and process methods/inventions.

It is still a further objective of the present invention to obtain a product-temperature-rise that is almost equal to the adiabatic-temperature-rise by means of pressurization.

It is yet another objective to apply these homogeneous temperatures in such a way that the mildest possible product treatment process can be used, providing minimum reduction of quality by applying the lowest initial-product-temperature.

It is yet another objective to apply these homogeneous temperatures so that the pressure or the number of pulses can be decreased and therefore the food treatment process can be performed at lower costs per kilogram of product.

These and other objectives and advantages of the present invention will become further apparent from the teachings hereinafter provided by the detailed description, test data, numerical calculations and examples.

### SUMMARY OF THE INVENTION

The present invention provides a method that combines one or more pressure pulses subjected to a preheated foodstuff resulting in a homogeneous temperature distribution in the pressure vessel. The combination of pressure and final-product-temperature results in a food treatment method on a commercial basis with the mildest conditions possible, i.e. the lowest initial temperature to obtain microbial safety by means of HPP. This can be done without negative side-effects that take place in conventional HPP sterilization processes. Obtaining a homogeneous temperature distribution in the pressure vessel is the elementary factor in this invention. This is achieved by means of:

1 A large pressurization rate (>5 MPa·s⁻¹); due to this fast pressurization, minimal energy is exchanged between the product and the HPP-system (hence, vessel wall). This results in a homogeneous product-temperature-rise that is almost equal to the adiabatic-temperature-rise. In systems in which the pressurization rate is less than 5 MPa·s⁻¹ (e.g. 3 min to pressurize a vessel to 700 MPa), the temperature rise is not homogeneous and smaller than the adiabatic-temperature-rise, due to cooling while pressurizing the system. This implies that the product fraction near the HPP vessel wall has a temperature that is lower than the temperature in the center of the vessel (and thus the product core). Fast pressurization can be obtained for instance by using a system with an internal intensifier such as described in WO99/61146 in the name of applicant, which is incorporated herein by reference.

2 Applying a vessel material with low heat transfer properties (less than 25 W·m⁻¹·K⁻¹, preferably less than 10 W·m⁻¹·K⁻¹, most preferably less than 1 W·m⁻¹·K^{-l}). This technical solution reduces energy transfer from the food product to the HPP vessel, and thus keeps the product fraction near the wall at a high temperature. Vessel materials suitable for this application are among others HDPE, PEEK, UHMWPE, PVC, EP, POM, natural and synthetic fibers embedded or not in a natural synthetic, or metallic matrix or materials as described in patent EP 0842696. It is possible to apply these materials to the inner part of the HPP-vessel only or using a product container constructed from these materials.

3 Applying a vessel material with an adiabatic-temperature-rise that is similar or higher than the adiabatic-temperature-rise of the food product (1-8 K per 100 MPa). This similar or higher adiabatic-temperature-rise compensates heat leaks. Vessel materials suitable for this application are among others HDPE, PEEK, UHMWPE, PVC, EP, POM, natural or synthetic fibers embedded or not in a natural, synthetic or metallic matrix. It is possible to apply these materials to the inner part of the HPP-vessel only or using a product container constructed from these materials.

4 Avoiding heat loss from the product to cold (relative to the initial-product-temperature) pressure fluid entering the pressure vessel. This might be obtained (a) by the use of an internal intensifier system or (b) by heating the high-pressure pipes and/or the high-pressure pump (external intensifier system) or (c) by avoiding (thermal) contact between the pressure liquid entering the vessel and the product to be treated, for instance by inserting the product in a product container.

5. The adiabatic temperature rise of the pressure medium must be the same or larger than the adiabatic temperature increase of the product to obtain a similar final-product-temperature. A smaller temperature increase will result in cooling of the product.

Acceptable results might also be obtained by a combination of one or more of these inventions. Whether only one, two, three, four, all, or a combination of these methods are being applied, depends i.a. on costs in relation to the improvement. For example in a laboratory HPP vessel, only applying a product container inside the HPP vessel might result in sufficiently controlled temperature conditions. The combined effect of all five methods above mentioned is presented in FIG. 2.

An additional method to achieve a homogeneous temperature distribution is to apply a vessel-temperature that is higher than the initial-product-temperature. The vessel-temperature can be pre-set to a value between the initial-product-temperature and the final-product-temperature, or even slightly above the latter temperature. This method is also mentioned by Meyer and the FDA, but has been proven of limited value in conventional HPP systems, because it results in an overheating of the product, especially the product fraction near the wall; indeed, in the conventional HPP systems the time before the product is pressurized, is long (e.g. sum of filling time, closing time and pressurization time is generally >1 min.), and during this period the product is in contact with the hot vessel wall. This overheating will therefore automatically result in a decrease of product quality, or even unacceptable boiling (see FIG. 3) if the vessel would be set to a temperature above the boiling temperature. However, in a HPP system that uses methods 1 and 2 described above, preferably in combination with a fast closing system (for instance with an axial, hydraulically actuated lid, as mentioned in patent WO99/61146), it is possible to pre-set a vessel-temperature that is substantially higher than the initial-product-temperature, without overheating the product fraction near the vessel wall, and thus without decrease of product quality (see FIGS. 7 and 8) even when the vessel is set to a temperature above the boiling temperature.

A system with a working principle based on inherent and passive physical processes (adiabatic-temperature-rise), provides a safe, robust and reliable process. The points 1-3 and 4a, are therefore preferable above the technical solutions known from the prior art.

The combination of the final-product-temperature and working pressure, causes in the preservation effect. This invention reduces the energy flux from the food product towards the HPP vessel, resulting in a maximal and homogeneous temperature in the entire food product. Therefore, compared to systems where no homogeneous temperature distribution is achieved, a lower initial-product-temperature may be used, and still the same minimal final-product-temperature will be achieved in the food product.

Most researchers did not use methods that achieve homogeneous temperature, but still sterility is obtained and reported in numerous patents (Meyer, Wilson) and scientific articles; it can thus be concluded that a fraction of the product has been treated at the final-product-temperature at the wall (T_{1,wall}), which is lower than to the almost always reported final-product-temperature at the center of the vessel (T_{1,centre}), and thus that sterility can be achieved at temperatures that are lower than the temperatures reported in previous patents and scientific articles (sterilization effect by means of temperature is in synergy with pressure). If the technical methods of this invention are applied, every fraction of the product can be maintained at the lowest of the above temperatures, and still sterility will be achieved.

Therefore, when applying the methods of this invention, the initial-product-temperature may be lower or the working pressure may be reduced, compared to the case where a conventional HPP system is used. An initial-product-temperature below 70° C. (approximately 60° C.) may be applied to obtain the same level of microbial inactivation as similar pressure treatment on a conventional HPP system with an initial-product-temperature of 70° C. This is also demonstrated in Table 1, and in Example 1.

Alternatively, the methods of this invention can be used to decrease the processing cost of an HPP process; one way is to lower the pressure of each pulse, and still obtain the same level of microbial inactivation, as demonstrated in Table 2 and Example 2; a second way is to reduce the number of pulses, and still achieve the same level of microbial inactivation, as demonstrated in Example 3.

Different detection methods for micro-organisms, result in the same level of inactivation (see Example 4). This applies for both 1-pulse and 2-pulse treatment, there is no indication for recovery of spores during storage.

TABLE 1
decrease of initial-product-temperature due to this invention,
while retaining the same level of inactivation.

| 700 MPa | T₀ | T_{1,wall} | T_{1,centre} |
|---|---|---|---|
| Conventional HPP-system | 90° C. | 114° C. | 123° C. |
| This invention | 83° C. | 114° C. | 114° C. |

TABLE 2
decrease of pressure due to this invention,
while retaining the same level of inactivation.

| T₀ = 70° C. | p | T_{1,wall} | T_{1,centre} |
|---|---|---|---|
| Conventional HPP-system | 1000 MPa | 105° C. | 112° C. |
| This invention | 880 MPa | 105° C. | 105° C. |

### Example 1

Conventional HPP system, 70° C., 2 pulses of 960 MPa

vs

System according to this invention, 60° C., 2 pulses of 950 MPa

Result: same level of inactivation

### Example 2

Conventional HPP system; 90° C., 2 pulses of 750 MPa

vs

System according to this invention, 90° C., 2 pulses of 600 MPa

Result: same level of inactivation

### Example 3

Conventional HPP system, 90° C., 2 pulses of 750 MPa

vs

System according to this invention, 90° C., 1 pulse of 910 MPa

Result: same level of inactivation.

### Example 4

Comparison between the inactivation directly after an HPP treatment (plate count) compared to the inactivation after 30 days of storages (MPN-method)

Result: same level of inactivation.

### Example 5

Conventional HPP system at 90° C., product preheated to 90° C., 2 pulses of 700 MPa, holding time of each pulse 60 s

vs

System according to this invention at 105° C., product preheated to 90° C., 1 pulse of 700 MPa, holding time 150 s

Result: same level of inactivation

### Example 6

Conventional HPP system at 90° C., product preheated to 90° C., 1 pulse of 700 MPa, holding time 300 s

vs

System according to this invention at 105° C., product preheated to 90° C., 1 pulse of 700 MPa, holding time 150 s

Result: same level of inactivation.

This invention therefore describes methods to achieve (1) a high pressure preservation treatment of food product, (2) in a commercially viable/competitive way, (3) with minimal temperature treatment, (4) resulting in a minimum loss of product quality.

### BRIEF DESCRIPTION OF THE DRAWINGS

The invention will be explained in detail with reference to the accompanying drawings:

FIG. 1 is a graphical representation of a time-temperature-pressure relation of a high-pressure process in a typical commercial HPP-system;

FIG. 2 is a graphical representation of a time-temperature-pressure relation of a high-pressure process in a system in which the methods of this invention are applied;

FIG. 3 is a graphical representation of a time-temperature-pressure relation of a high-pressure process in a typical commercial HPP system as in FIG. 1, but with the vessel-temperature increased;

FIG. 4 is a graphical representation of a time-temperature-pressure relation of a high-pressure process according to this invention with only one pulse and a long pressure holding time;

FIG. 5 is a graphical representation of a time-temperature-pressure relation of a high-pressure process in a system with fast pressurization but without an inner HPP vessel material with low heat transfer properties;

FIG. 6 is a graphical representation of a time-temperature-pressure relation of a high-pressure process in a system with an inner HPP vessel material with low heat transfer properties, but without fast pressurization;

FIG. 7 is a graphical representation of a time-temperature-pressure relation of a high-pressure process according to this invention where an elevated vessel-temperature is used;

FIG. 8 is a graphical representation of a time-temperature-pressure relation of a high-pressure process according to this invention where an elevated vessel-temperature is used;

FIG. 9 is a graphical representation of a time-temperature-pressure relation of a high-pressure process in a system with fast pressurization, an elevated vessel-temperature, but no inner HPP vessel material with low heat transfer properties;

FIG. 10 is a graphical representation of a time-temperature-pressure relation of a high pressure process in a system with slow pressurization, an elevated vessel-temperature, and an inner HPP vessel material with low heat transfer;

FIG. 11 represents a system according to this invention;

FIGS. 12a-12c schematically represents the operation of a system according to this invention;

FIG. 13 is a graphical representation of a time-temperature-pressure-inactivation relation of a high pressure process in a conventional system;

FIG. 14 is a graphical representation of a time-temperature-pressure-inactivation relation of a high pressure process in a system according to this invention; and

FIG. 15 is a graphical representation of a time-temperature-pressure-inactivation relation of a high pressure process in a conventional system.

### DETAILED DESCRIPTION OF THE INVENTION

In this description the following definitions apply:

HPP: High Pressure Processing; processing of products by means of high isostatic pressure technology.

Initial-product-temperature T₀: the temperature of the product before it is inserted into a HPP vessel.

Final-product-temperature T₁: the temperature of the product after it has been pressurized to a high pressure and maintained on this high pressure. T_{1,wall} refers to the final-product-temperature of the product fraction at the wall of the vessel. T_{1,centre} refers to the final-product-temperature of the product fraction at the center of the vessel.

Vessel-temperature Tᵥₑₛₛₑₗ: the temperature of the HPP vessel. This temperature may be equal to the initial-product-temperature, but also a different vessel-temperature (e.g. higher) is possible

Adiabatic-temperature-rise ΔT_{ad}: the (theoretical) temperature increase occurring when a system is pressurized adiabatically. A process is adiabatic when no heat is transferred between product (pressurized system) and its surrounding.

Product-temperature-rise ΔT: the actual temperature increase of the product due to compression. The product-temperature-rise is therefore the difference between the final-product-temperature and the initial-product-temperature. Under ideally isolated circumstances, the product-temperature-rise would be equal to the adiabatic-temperature rise.

Pulse: part of a complete high pressure treatment, consisting of the following steps: pressurizing the system starting from atmospheric pressure up to the desired working pressure, holding time at working pressure, and depressurizing to atmospheric pressure.

Cycle: the complete high pressure treatment including insertion of the product, treating the product (by one or more pressure pulses), and removing the product.

Conventional system: a HPP system is considered to be conventional if it is a currently available system with steel vessels, that does not have one or more of the features mentioned in this patent.

The term ‘food’ should be considered as all products sensitive to microbial of enzymatic spoilage. This is not only the case for food products, but also for e.g. pharmaceutical products.

The present invention combines one or more pressure pulses subjected to a preheated spoilable product, in such a way that cooling is minimized and the temperature in the pressure vessel remains close to its theoretical final value. The combination of pressure and final-product-temperature (i.e. after pressurization) results in a food treatment method on a commercially competitive basis, with the lowest initial-product-temperatures, hence the mildest treatment possible. Obtaining a homogeneous temperature distribution is the elementary factor in this invention. Summarized this invention describes methods to achieve (1) high pressure preservation treatment of food product, (2) in a commercially competitive way, (3) with minimal temperate treatment, (4) resulting in a minimal loss of product quality.

To reduce both cost and thermal damage, a short cycle time is essential. The total cycle time is determined by (1) filling the HPP system with food product, (2) closing the system, (3) press the system, (4) keeping the HPP system at a high pressure, and (5) releasing the pressure from the system. The time needed for 1,2,3,5 are mainly influenced by the technical properties of the HPP system. The holding time, 4, is mainly related to e.g. the microbial effects necessary to extend the shelf life of the product. Generally, his holding time will decrease when the pressure is increased or when the final-product-temperature is increased. Redesigning in order to achieve a higher working pressure is an expensive solution, however, by e.g. applying new materials, cost effective systems may soon by offered (see patent EP 0842696 and WO 99/61146). Increasing the final-product-temperature can be achieved by increasing the pressure, or by increasing the initial-product-temperature; increasing the initial-product-temperature generally is unfavorable, as product quality decreases (e.g. flavor is reduced, texture changes, color changes).

When a system is pressurized, energy is added to the system, which results in a temperature rise. If no energy is transferred between the system and its surrounding, the process is defined to be adiabatic. The product-temperature-rise due to pressurizing under adiabatic conditions is called the adiabatic-temperature-rise. No heat transfer, hence an adiabatic process, occurs when a system is pressurized infinitely fast (dp/dt=∞MPa·s⁻¹), thus instantaneously, or when the thermal insulation between the system and its surrounding is perfect (K=0 W·m⁻¹·K⁻¹). In conventional HPP systems, adiabatic HPP does not exist; energy is always transferred, and therefore the product-temperature-rise of the product fraction near the HPP vessel wall is smaller than the adiabatic-temperature-rise. In many scientific articles and patents, the term adiabatic-temperature-rise is used in situations that are not adiabatic, this might lead to misinterpretation. This invention aims to obtain circumstances in which the theoretical adiabatic-temperature-rise is approached in the entire pressure vessel.

Based on literate it is known that final-product-temperature and pressure have a synergetic effect on the reduction of microorganisms. Meyer showed that a final-product-temperature of T₁=123° C. (T₀=90° C.) in combination with two pressure pulses of 700 MPa, or a T₁=111° C. (T₀=70° C.) in combination with two pressure pulses of 1000 MPa, provide sterility. Hence, when the pressure is increased, the final-product-temperature needed to obtain a certain amount of inactivation of microorganisms, spores or enzymes, will be lower. To process a product on a pre-defined final-product-temperature/pressure combination is complicated. Due to pressurization, the initial-product-temperature increases, The final-product-temperature is the sum of initial-product-temperature and the product-temperature-rise due to pressurization, which is a result of the adiabatic-temperature-rise, minus the temperature loss due to heat exchanged between the product and its surroundings. The effect of pressure heating is well known and also described in e.g. Wilson and Meyer and many others. However, Wilson and Meyer mention an initial-product-temperature/pressure combination to provide a preservative effect, however the product-temperature-rise is called the adiabatic-temperature-rise in their patents. Preferably one uses the term product-temperature-rise since the theoretical maximum temperature rise, the adiabatic-temperature-rise, will not be obtained in many practical systems due to heat losses.

To quote a recent FDA report (US Food and Drug Administration, Center for Food Safety and Applied Nutrition, Kinetics of Microbial Inactivation for Alternative Food Processing Technologies, IFT/FDA Contract No. 223-98-2333, 2 Jun. 2000): “The use of elevated temperatures as part of a specified HPP process will require monitoring the food temperature during the process to ensure every element of the food is at or above the specified temperature”. In an other part of this FDA report a warning towards researcher is given: “For this reason care must be taken in keeping a food sample at constant temperature during pressure treatment or determining the temperature of the food during compression and decompression. Most food researches working on pressure treatment of foods do not control the temperature during pressure treatment. Temperature control would be necessary to obtain meaningful microbial or enzymatic inactivation kinetics.”

Many researches working on pressure treatment of foods do not control the temperature during pressure treatment. Most researchers did not use methods that achieve homogeneous temperature but still sterility is obtained and reported in numerous patents (Meyer, Wilson) and scientific articles; it can thus be concluded that a fraction of the product has been treated at the final-product-temperature at the wall, which is lower than the always reported final-product-temperature at the center of the vessel, and thus that sterility can be achieved at temperatures that are lower than the temperatures reported in previous patents and scientific articles.

The present invention provides a method that combines one or more pressure pulses subjected to a preheated product resulting in a homogeneous temperature distribution. The combination of pressure and final-product-temperature results in a treatment method on a commercial basis with the lowest initial-product-temperature, hence the mildest conditions possible. This can be done without the negative side effects that take place in traditional sterilization processes (e.g. flavor is reduced, texture changes, color changes). Obtaining a homogeneous temperature distribution is the elementary factor in this invention. This is achieved by:

1 A large pressurization rate (>5 MPa·s⁻¹);

2 Applying a vessel material with low heat transfer properties (less than 25 W·m⁻¹·K⁻¹;

3 Applying a vessel material with an adiabatic-temperature-rise that is similar or higher than the adiabatic-temperature-rise of the product (1-8 K per 100 MPa);

4 Avoiding heat loss from the product to cold (relative to the initial-product-temperature) pressure fluid entering the pressure vessel;

5 The adiabatic temperature rise of the pressure medium must be the same or larger than the adiabatic temperature increase of the product to obtain a similar final-product-temperature.

Acceptable results might also be obtained by the partial combination of these. Whether only one, two, three, four, all, or a combination of these methods are applied, depends on the costs in relation to the improvement. For example in a laboratory HPP vessel, only applying a product container inside the HPP vessel might result in sufficiently controlled temperature conditions. The combined effect of all five methods above (1, 2, 3, 4 and 5) is given in FIG. 2.

To demonstrate the importance of this invention, two experiments have been performed (Example 1), in order to compare a system in which the temperatures are not controlled, to a system in which the temperatures are controlled. A pressure cycle as proposed by Meyer was applied to a spore suspension, in order to determine the microbial reduction of this spore suspension. The experiments where conducted in a laboratory system consisting of a steel vessel and a high-pressure external intensifier system. In the first test, the spore suspension was preheated to an initial-product-temperature of 70° C., pressurized to 960 MPa, released to ambient pressure, pressurized a second time to 960 MPa, and finally released to ambient pressure; a decimal spore reduction of 6D was obtained (plate count method). In a second test a thick plastic product container (insulation around all sides of the product) was used, in order to avoid heat flow between product and HPP vessel wall. The same test was done as in the first test, but the initial-product-temperature was only 60° C. and the pressure pulses were fixed at 950 MPa. Also in this test a microbial reduction of 6D was obtained (see Example 1).

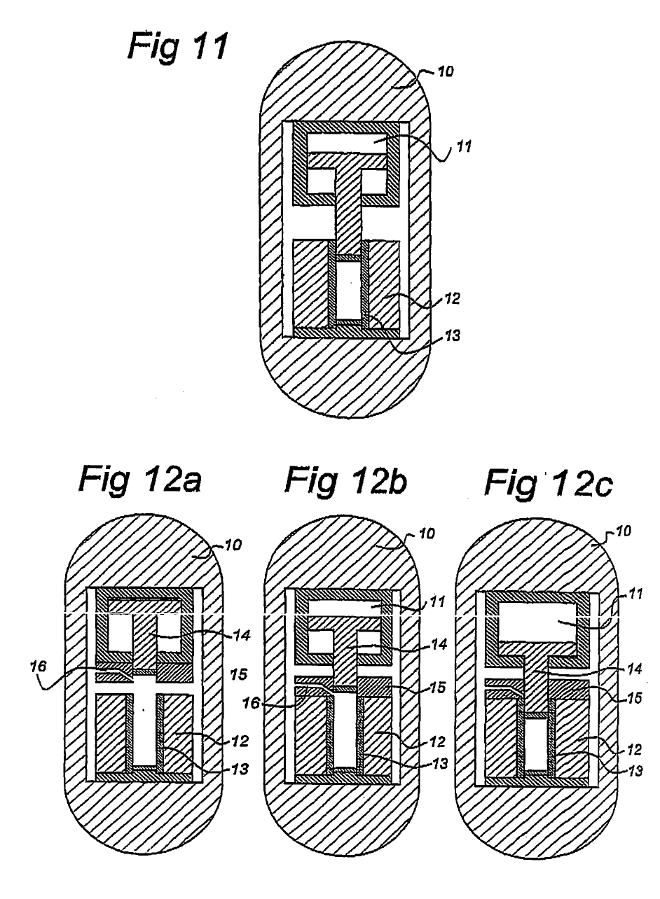

The methods described in this invention have been applied in a HPP equipment in accordance with EP 0842696 and WO99/61146. It is a HPP system with an internal intensifier, and can be pressurized up to 1000 MPa in less than 20 seconds. The vessel has been equipped with a food-grade, replaceable inner layer, which has been constructed from materials as described in this invention; this inner part of the HPP vessel is also called liner (see FIG. 11). The HP vessel is made from high-strength-steel, but a vessel made from composite material can be used as well. The equipment mentioned also uses the fast loading-unloading feature (an axial, hydraulically actuated lid, as described in patent WO99/61146), minimizing the handling time, hence the total cycle time, and therefore the costs per kg product.

In this labscale-equipment the final-product-temperature was measured as function of the pressurization rate; compared to slow pressurization (90 s), the final-product-temperature was 5° C. higher when pressurized quickly (20 s). Hence fast pressurization is an effective method and therefore a part of this invention. The combination of a plastic liner and fast pressurization rate will therefore result in a system that is even more efficient than the system with a plastic product container only that has been used for the microbiological experiments (Example 1).

To illustrate the effectiveness of the combination of all the methods described in this invention, a numerical heat transport model is used. An axi-symmetric one-dimensional Finite Element Model (FEM) of the HPP system was used. Hence the model can be used to predict the temperature at any given radial location inside the system at any given time. One may argue that besides heat conduction, heat convection might be important as well, result in a smaller temperature gradient. In reality however, heat convection hardly occurs in HPP systems since (a) the viscosity rises with increasing pressure, (b) small consumer pouches can be used, these will not ‘move’ through the HPP vessel, (c) in solid products only heat conduction takes place.

The internal vessel diameter of this HPP system is 100 mm, which is comparable to the internal diameter of many commercially available HPP vessels. The amount of heat transfer depends on the ratio between volume and internal surface of a HPP vessel. Ten different cases were simulated using this model. The following parameters have been varied in these cases: (1) the HPP cycle time (‘low’ or ‘high’, see Table 3a), (2) the use of a liner with effective thermal insulation, (3) the vessel-temperature Tᵥₑₛₛₑₗ. The initial-product-temperature has been fixed to 70° C. for all cases. Working pressure and pressure holding time have been chosen such that microbiological effects were available for evaluation (a cycle of two pressure pulses of 1000 MPa with a pressure holding time of 30 seconds and a pause time between the two pulses of 30 seconds, see also Table 3a). The product is assumed to have (thermal) properties similar to those of water, and both the product and the liner material are assumed to have an adiabatic-temperature-rise of 4.2 K per 100 MPa. Some examples of the adiabatic temperature rise of food products is given in Table 4b.

TABLE 3a
FEM parameters used to compute the two-pulse HP processes

| | | | | | |
|---|---|---|---|---|---|
| Load | Pressuriz. | Hold | Depress. | | Unload |
| (s) | (MPa · s⁻¹) | (s) | (s) | Pause (s) | (s) |

| | | | | | | |
|---|---|---|---|---|---|---|
| ‘Low’: conventional HPP-system | 90 | 2.5 | 30 | 30 | 30 | 90 |
| ‘High’: this invention. | 40 | 33.3 | 30 | 15 | 30 | 40 |

TABLE 3b
FEM parameters

| | Heat transfer | Adiabatic temp. | | Heat | |
|---|---|---|---|---|---|
| Pressurization | of inner | rise of inner | | transfer of | |
| rate ¹ | vessel wall | vessel wall | Tᵥₑₛₛₑₗ | vessel ⁴ | Remark |
| low | high | 0 K/100 MPa | 70° C. | high | System A |
| high | low | 4.2 K/100 MPa | 70° C. | low | System D |
| low | high | 0 K/100 MPa | 100° C. | high | |
| high | low | 4.2 K/100 MPa | 70° C. | low | ² |
| high | high | 0 K/100 MPa | 70° C. | high | System C |
| low | low | 4.2 K/100 MPa | 70° C. | high | System B |
| high | low | 4.2 K/100 MPa | 100° C. | low | |
| high | low | 4.2 K/100 MPa | 100° C. | high | |
| high | high | 0 K/100 MPa | 100° C. | high | |
| low | low | 4.2 K/100 MPa | 100° C. | high | |

⁰ in all calculations, the initial-product-temperature is 70° C.
¹ the pressure cycles used are given in Table 3a; ‘low’ corresponds to conventional, ‘high’ corresponds to this invention.
² Only one pressure pulse with a longer pressure holding time.
³ Note that no FEM calculation has been done to simulate the entrance of unheated pressure liquid in the vessel; this would further increase the temperature differences between the hottest and the coldest spots in the product.
⁴ a steel vessel wall has high heat transfer, a vessel constructed from fibers (EP0842696) has a low heat transfer.

TABLE 4a
Adiabatic-temperature-rise of water.

| T₀ | ΔT_{ad} (at 700 MPa) | ΔT_{ad} (at 1000 MPa) |
|---|---|---|
| 70° C. | 29.6° C. | 41.5° C. |
| 90° C. | 33.2° C. | 45.8° C. |

TABLE 4b
Adiabatic-temperature-rise of some food products.

| product | T₀ | ΔT_{ad} (at 950 MPa) |
|---|---|---|
| Cheese | 20° C. | 34.0° C. |
| Chicken | 20° C. | 29.5° C. |

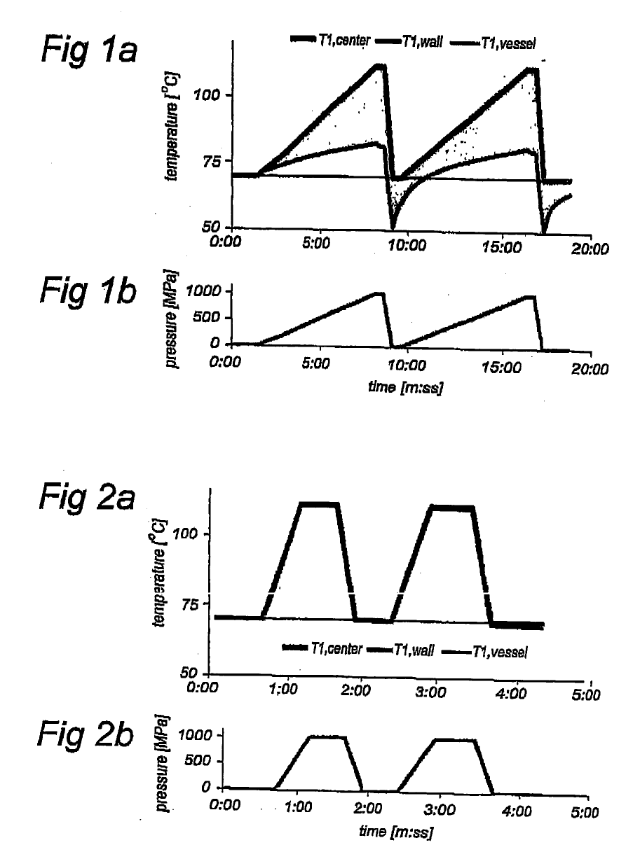

To illustrate the effect of using a plastic layer (e.g. product container or liner), systems A and B have been compared. The first system is a HPP system with a steel vessel (system A, FIG. 1), which has a relatively low pressurizing rate. The product-temperature-rise in the center of the HPP vessel is almost equal to the adiabatic-temperature-rise (ΔT=ΔT_{ad}=41.5° C.). The product-temperature-rise of the product faction near the wall is much lower than the adiabatic-temperature-rise (ΔT=12° C.≠ΔT_{ad}). Hence, the final-product-temperature gradient between center and fraction near the wall is T_{1,centre}−T_{1,wall}=30° C. (FIG. 1), thus the temperature distribution is non-homogeneous. If a layer of 5 mm of material with low heat transfer properties, and with an adiabatic-temperature-rise of the same order as the adiabatic-temperature-rise of the food product, is applied in the inner part of the same vessel (system B, FIG. 6), the product-temperature-rise in the center of the HPP vessel is again almost equal to the adiabatic-temperature-rise (ΔT=ΔT_{ad}=41.5° C.), but now the product-temperature-rise of the product fraction near the wall is much higher, although still not equal to the adiabatic-temperature-rise (ΔT=36° C.≠ΔT_{ad}); hence the difference between wall and center temperature is T_{1,centre}−T_{1,wall}=5° C., a large improvement compared to system A. In these calculations a HPP vessel of commercial size was used, in small laboratory systems these effects are even much more important, since the surface-volume ratio is larger and therefore cooling is more prominent.

In the previous section the effect of a layer with low heat transfer properties and an adiabatic-temperature-rise of the same order as the adiabatic-temperature-rise of the food product was demonstrated. The temperature increase of several available materials, a well known phenomena also reported in literature (Rodriguez et al. Journal of Material Science, Vol. 22 (1987)), have been determined experimentally. The result of this test are present in Table 5:

TABLE 5
measured temperature rise due to pressurization
(T₀ = 20° C., average 0-700 MPa)

| | ΔT/Δp |
|---|---|
| | (K/100 MPa) |
| PE | 4.5 |
| PVC | 3.4 |
| HDPE | 4.4 |
| Rulon | 2.9 |
| Ertalite | 3.3 |

One may conclude that materials exist with a temperature rise that is similar, larger or smaller than the product being processed, and that these materials also demonstrate a low heat transfer coefficient. Application of liners based on these materials compensates heat leaks and reduces the ‘driving force’ (temperature difference between product and vessel wall). The effect of this (partial) solution on the microbial reduction was already mentioned: if a plastic layer is used, a 6D spore reduction can still be obtained if the initial-product-temperature is 10° C. lower than in a system that does not have such a layer (see Example 1).

The same phenomena of local cooling as illustrated in Example 1 also occurs if the adiabatic temperature rise of the pressure medium is lower than the adiabatic temperature rise of the product. Hence, the adiabatic temperature rise must be the same or larger than the adiabatic temperature rise of the product preventing heat exchange between the pressure medium and the product when the system is pressurized.

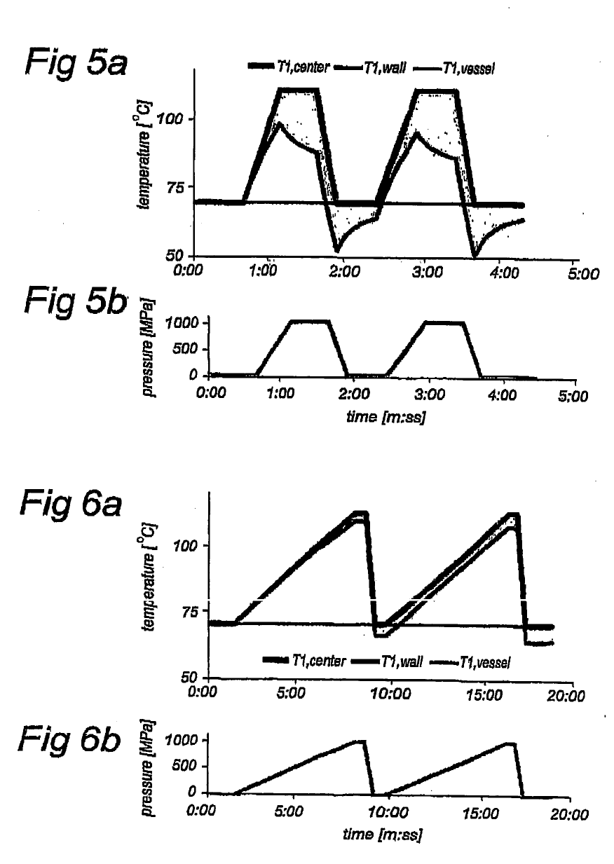

To illustrate the effect of the pressurization rate (MPa·s⁻¹), a comparison has been made between two systems (system A and system C). The first one is a HPP-system based on a low pressurization rate (A), the second system is a system with a high pressurization rate (C). In system A, the final-product-temperature difference between the center and fraction near the wall is T_{1,centre}−T_{1,wall}=30° C. (FIG. 1), in system C the difference is reduced to T_{1,centre}−T_{1,wall}=24° (FIG. 5). Therefore, it can be concluded that fast pressurization reduces the temperature difference in the center and near the HPP wall.

The result of the combination of the methods of this invention is illustrated in FIG. 2 (system D). In this figure the effect of fast pressurization and the application of a heat isolating layer, which has an adiabatic-temperature-rise similar to the product, is illustrated. The temperature at the hottest and the coldest product spots are almost identical, and almost equal to the adiabatic-temperature-rise. Hence, due to this invention, a homogeneous temperature distribution may be obtained.

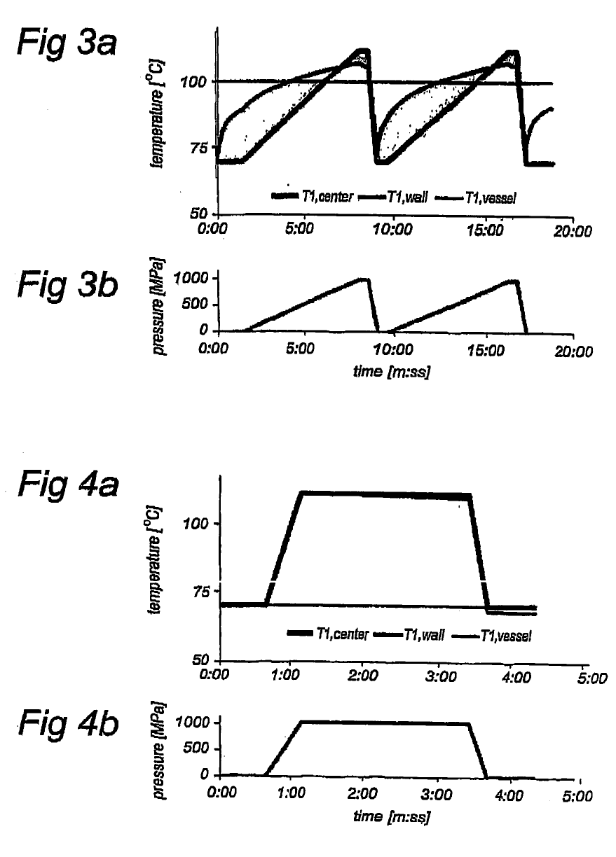

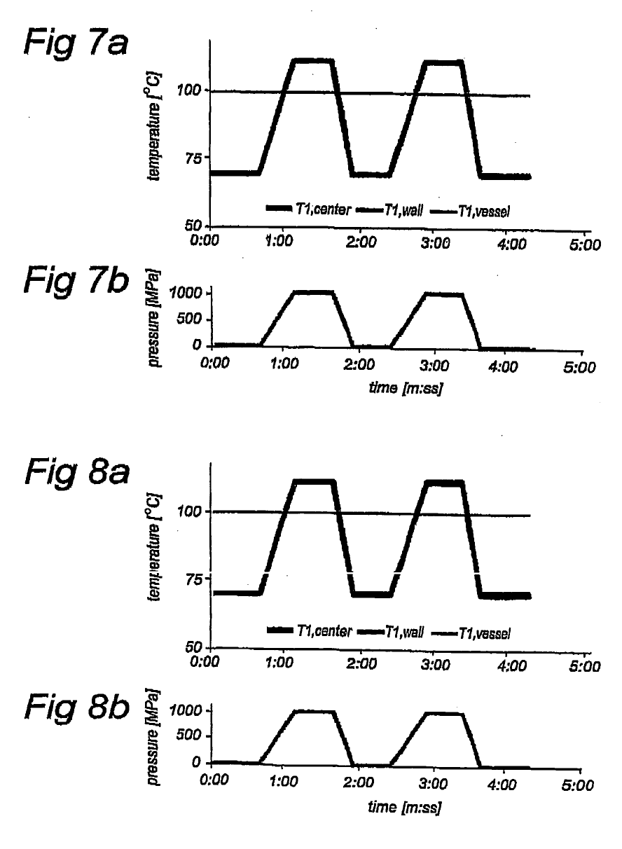

An additional method to achieve a homogeneous temperature distribution is to apply a vessel-temperature which is higher than the initial-product-temperature. The vessel-temperature can be fixed at a value between the initial-product-temperature and the final-product-temperature, or even slightly above this temperature. This method is also mentioned by Meyer and the FDA, but has been proven of limited value in conventional HPP systems, because it results in overheating of the product especially the product fraction near the wall; indeed, in the conventional HPP systems the time before the product is pressurized is long (e.g. sum of filling time, closing time and pressurization time is generally >>1 min.), and during this period the product is in contact with the hot vessel wall. This overheating will therefore automatically result in a decrease of product quality, or even unacceptable boiling (see FIG. 3) if the vessel would be set to a temperature above the boiling temperate. However, in a HPP system that uses methods 1 and 2 described above, ably in combination with a fast closing system (for instance with a axial, hydraulically actuated lid, as mentioned in patent WO 99/61146), it is possible to set a vessel-temperature that is substantially higher than the initial-product-temperature, without overheating the product faction near the vessel wall, and thus without decrease of product quality (see FIGS. 7 and 8) even when the vessel is set to a temperature above boiling.

Summary of the conclusions and remarks so far:

There is a relation between the final-product-temperature, the pressure, the number of pulses within a HPP cycle, and the reduction/inactivation of spores and microorganisms.

In conventional HPP systems the final-product-temperature distribution is not homogeneous, the product fraction near the wall has a lower temperature than the product fraction in the center of a HPP vessel. Most HPP systems are equipped with thermocouples based in the center of the HPP system.

The final-product-temperature is the sum of initial-product-temperature T₀ and the product-temperature-rise ΔT, under perfect adiabatic circumstances this temperature rise would be equal to the adiabatic-temperature-rise.

With this invention, an almost perfect homogeneous temperature distribution may be obtained, with product-temperature-rise within every fraction of the vessel almost equal to the adiabatic-temperature-rise.

The effectiveness of this invention is demonstrated using FEM, and by applying measurements in a system constructed according to the methods of this invention (labscale equipment). Due to this invention every fraction of the product is raised to a homogeneous final-product-temperature, with a temperature rise almost equal to the adiabatic-temperature-rise.

The mildest treatment consists of the lowest final-product-temperature and p, and not as reported by many researchers the final-product-temperature in the center of the vessel and p. This is illustrated by microbiological experiments, since milder conditions (lower T₀ and Pressure) provide similar spore reduction.

Many researchers did not use methods that achieve homogeneous temperature, but still sterility is obtained and reported in numerous patents (Meyer, Wilson) and scientific articles. Therefore, it may be concluded that a fraction of the product has been treated at the final-product-temperature at the wall that is lower than to the almost always reported final-product-temperature at the center, and thus that sterility can be achieved at temperatures that are lower than the temperatures reported in previous patents and scientific articles. If the technical methods of this invention are applied, the product can be maintained at the lower final-product-temperature at the wall that was present in the extents of other researchers, and still sterility will be achieved. Therefore, when using the methods of this invention, the initial-product-temperature may be lower than in the case where a conventional HPP system is used. An initial-product-temperature substantially below 70° C. (approximately 60° C.) can be applied to obtain a level of microbial inactivation that is the same as a similar pressure treatment on a conventional HPP system, with an initial-product-temperature of 70° C. Examples are demonstrated in Table 6, and in Example 1. Alternatively, the methods of this invention can be used to decrease the processing costs of an HPP process; one way is to lower the pressure of each pulse, and still obtain the same level of microbial inactivation, as demonstrated in Table 7 and Example 2. Another way is to decrease the number of pulses, and still achieve the same level of microbiological inactivation, as demonstrated in Example 3.

TABLE 6
decrease of initial-product-temperature due to this invention (same
p-T treatment, same level of inactivation)

| p = 700 MPa | T₀ | T_{1,wall} | T_{1,centre} |
|---|---|---|---|
| Conventional HPP-system | 90° C. | 114° C. | 123° C. |
| This invention | 83° C. | 114° C. | 114° C. |

TABLE 7
decrease of pressure due to this invention (same p-T treatment,
same level of inactivation)

| T₀ = 70° C. | p | T_{1,wall} | T_{1,centre} |
|---|---|---|---|
| Conventional HPP-system | 1000 MPa | 105° C. | 112° C. |
| This invention | 880 MPa | 105° C. | 105° C. |

In addition to the summary of the conclusions and remarks as presented before:

A system has been constructed as described herein, and in accordance with EP 0842696 and WO 99/61146.

Due to the methods of this invention, for a given pressure treatment a lower initial-product-temperature T₀ may be used, resulting in a process with increased product quality, when compared to a product treated in conventional HPP systems.

Due to the methods of this invention, for a given initial-product-temperature, a lower pressure may be used, resulting in a process with increased product quality and with a lower cost per kg of product treated, when compared to a product treated in conventional HPP systems.

Due to the methods of this invention, less pressure pulses may be used, resulting in a process with a lower cost per kg of product treated, when compared to a product treated in conventional HPP Systems.

In all previous cases, less energy is needed per kg of product treated, as well as a shorter cycle time, and therefore lower cost per kg of product treated results.

This invention provides a method to apply these homogeneous temperatures in such a way that the mildest possible food treatment process can be used, providing minimal reduction of quality.

This invention therefore describes methods to achieve (1) high pressure preservation treatment of food product, (2) in a commercially viable way, (3) with minimal temperature treatment, (4) resulting in a minimal loss of product quality.

### EXAMPLES

In the examples 1-3, inactivation of bacterial endospores in a system according to this invention was compared to conventional HPP System Bacillus stearothermophilus was chosen as a target organism because its spores belong to the most heat resistant known. For production of spores, Bacillus stearothermophilus strain Merck 11499 was cultivated on a solid medium containing 15 g·1⁻¹ agar, 8 g·1⁻¹ nutrient broth, 0.51 g·1⁻¹ MgSO₄, 0.97 g·1⁻¹ KCl, 0.2 g·1⁻¹ CaCl₂·2H₂O, 3 mg·1⁻¹ MnCl₂·4H₂O, and 0.55 mg·1⁻¹ FeSO₄·7H₂O, The pH of this medium was set to 6.9 prior to autoclaving. After 7 days of incubation at 55° C., spores were harvested, washed in demineralised water, and stored at 7° C. Spores produced according to this procedure were characterized by a thermal decimal reduction time D at 120° C. of 8.8-9.9 min. and a z-value of 6.5-6.7° C. For high pressure treatments, spores were suspended in tryptone soy broth to a final density of 10⁶-10⁷ spores ml⁻¹. Three ml aliquots of this suspension were transferred to PE pouches. The pouches were heat-sealed and stored on ice until processing.

High pressure treatments were conducted in a BP system with a maximum working pressure of 1000 MPa. In order to prevent heat loss during pressurization, a sample holder made of HDPE was designed. The lid and bottom of the sample holder were also constructed from HDPE to prevent the cooling through the vessel lid The PP vessel lid was also preheated minimizing the temperature gradient between the (adiabatic) heated sample and the vessel lid, Applying this approach results in a homogeneous temperature distribution. To illustrate the effect of his invention, also experiments were conducted without use of the sample holder, in way a large temperature gradient between product fraction in the center of the vessel and the product faction near the vessel wall occurs. This temperature uncontrolled HPP system, is called conventional in the following examples.

High pressure treatments were conducted according to the following scheme. The vessel, the vessel lid, the sample holder, and the pressure liquid were all conditioned to the desired initial temperature. The pouches containing the spore suspensions were preheated for 1 min. at the desired initial-product-temperature. After the vessel was closed, pressure was fir increased to 100 MPa in 15 s and subsequently to the desired working-pressure in 1 min. Holding time at this pressure was 2.5 min. Release of pressure was in 20 s. In case the same sample was treated with a second pressure pulse, this cycle was repeated after a pause of 1 min.

Spores in the untreated spore suspensions and surviving spores in the treated pouches were enumerated by pour plating in tryptone soy agar. Serial tenfold dilutions were made in a solution containing 0.9% (w/v) of sodium chloride and 0.1% (w/v) of peptone. Per plate 1 ml of inoculum was used. After 7 days of incubation at 55° C., colonies were counted and the viable count was calculated. The detection limit of this analysis was 10 CFU·ml⁻¹. This corresponded to 10 CFU on the plate inoculated with the undiluted spore suspension.

### Example 1

Conventional HPP system, 70° C., 2 pulses of 960 MPa

vs

System according to this invention, 60° C., 2 pulses of 950 MPa

Result: same level of inactivation

In the first series of experiments the initial process and product temperature was varied. The pulse height was set at 950 MPa and per treatment two similar pressure pulses were applied. Each treatment condition was evaluated in triplicate. Results are presented in Table 8. In the conventional set up, a treatment with two cycles of pressure pulses of 960 MPa applied at an initial temperature of 70° C. reduced the number of viable Bacillus stearothermophilus spores to a level below the detection limit of the plate count method (10 spores per ml). In the experimental set-up, this corresponded to a degree of spore inactivation of higher than 5.9 log unit. As can be seen in Table 8, the realized pulse height was slightly higher than intended. Using the methods of this invention, a degree of spore reduction varying from 5.7 to higher than 5.8 log units was obtained with an initial temperature of 60° C. The example demonstrates that with this invention a lower initial process and product temperature may be applied than with a conventional HPP system in order to obtain a similar degree of spore inactivation.

TABLE 8

| | | | | | Results | | |
|---|---|---|---|---|---|---|---|
| | | | | | Viable Count | | |
| | Treatment | | | | (¹⁰log CFU · ml⁻¹) | | |
| HPP | Initial T₀ | Final p | Number of | | Before | After | Decimal |
| system | (° C.) | (MPa) | pulses | Run nr | treatment | treatment | reduction |
| Conventional | 70 | 960 | 2 | 1 | 6.9 | <1.0 | >5.9 |
| | | | | 2 | 6.9 | <1.0 | >5.9 |
| | | | | 3 | 6.9 | <1.0 | >5.9 |
| According to | 60 | 950 | 2 | 1 | 6.8 | 1.1 | 5.7 |
| this | | | | 2 | 6.8 | 1.1 | 5.7 |
| invention | | | | 3 | 6.8 | <1.0 | >5.8 |

### Example 2

Conventional HP system, 90° C., 2 pulses of 750 MPa

vs

System according to this invention, 90° C., 2 pulses of 600 MPa

Result: same level of inactivation

In the second series of experiments the height of the pressure pulses was varied. The initial process temperature was 90° C. and per treatment two similar pressure pules were applied. Each treatment condition was evaluated in triplicate. Results are presented in Table 9. In the conventional set-up, two cycles of pressure pulses of 750 MPa reduced the number of viable Bacillus stearothermophilus spores by 5.1-5.5 log units. Using the methods of this invention, a 5.1-5.5 log reduction was obtained with two pressure pulses of 600 MPa. The example demonstrates that with this invention a lower pressure pulse may be applied than with a conventional HP system in order to obtain a similar degree of spore inactivation.

TABLE 9

| | | | | | Results | | |
|---|---|---|---|---|---|---|---|
| | | | | | Viable Count | | |
| | Treatment | | | | (¹⁰log CFU · ml⁻¹) | | |
| HPP | Initial T₀ | Final p | Number of | | Before | After | Decimal |
| system | (° C.) | (MPa) | pulses | Run nr | treatment | treatment | reduction |
| Conventional | 90 | 750 | 2 | 1 | 6.8 | 1.7 | 5.1 |
| | | | | 2 | 6.8 | 1.3 | 5.5 |
| | | | | 3 | 6.8 | 1.3 | 5.5 |
| According to | 90 | 600 | 2 | 1 | 6.7 | 1.6 | 5.1 |
| this | | | | 2 | 6.7 | 1.2 | 5.5 |
| invention | | | | 3 | 6.7 | 1.4 | 5.3 |

### Example 3

Conventional HPP system, 90° C., 2 pulses of 750 MPa

vs

System according to this invention, 90° C., 1 pulse of 910 MPa

Result: same level of inactivation.

In the third series of experiment the number and the height of the pressure pulses was varied. The initial-product-temperature was 90° C. Each treatment condition was evaluated in triplicate. Results ate presented in Table 10. In the conventional set up, two cycles of pressure pulses of 750 MPa reduced the number of viable Bacillus stearothermophilus spores by 5.1-5.5 log units. Using the methods of this invention, a degree of spore reduction varying from 4.5 to higher than 5.4 log units was obtained with one pressure pulses of 910 MPa. The example demonstrates that with this invention less pressure pulses may be applied than with a conventional HPP system in order to obtain a similar degree of spore inactivation.

TABLE 10

| | | | | | Results | | |
|---|---|---|---|---|---|---|---|
| | | | | | Viable Count | | |
| | Treatment | | | | (¹⁰log CFU · ml⁻¹) | | |
| HPP | Initial T₀ | Final p | Number of | | Before | After | Decimal |
| system | (° C.) | (MPa) | pulses | Run nr | treatment | treatment | reduction |
| Conventional | 90 | 750 | 2 | 1 | 6.8 | 1.7 | 5.1 |
| | | | | 2 | 6.8 | 1.3 | 5.5 |
| | | | | 3 | 6.8 | 1.3 | 5.5 |
| According to | 90 | 910 | 1 | 1 | 6.4 | <1.0 | >5.4 |
| this | | | | 2 | 6.4 | 1.1 | 5.3 |
| invention¹ | | | | 3 | 6.4 | 1.9 | 4.5 |

¹the singe pulse experiment is conducted using a holding time similar to the holding time of the first pulse in a 2-pulse experiment

### Example 4

In this example, spore suspensions treated according to this invention were evaluated for surviving spores immediately after treatment and after a storage period of 30 days. Spores of the bacterium Bacillus subtilis were used. This species is able to grow both aerobically and anaerobically at ambient temperature.

For production of spores, Bacillus subtilis strain 168 was cultivated on a solid medium containing 15 g·1⁻¹ agar, 8 g·1⁻¹ nutrient broth, 0.51 g·1⁻¹ MgSO₄, 0.97 g·1⁻¹ KCl, 0.2 g·1⁻¹ CaCl₂·2H₂O, 3 mg1⁻¹ MnCl₂·4H₂O, and 0.55 mg·1⁻¹ FeSO₄·7H₂O. The pH of this medium was set to 6.9 prior to autoclaving. After 5 days of incubation at 37° C., spores were harvested, washed in demineralised water, and stored at −20° C. For high pressure treatments, spore suspension tryptone soy broth were prepared containing 5.0·10⁷, 5.0·10⁶, 5.0·10⁵, 5.0·10⁴5.0·10³, and 5.0·10² spores·ml⁻¹. Three ml aliquots of these suspensions were transferred to PE pouches. The pouches were heat-sealed and stored on ice until processing.

High pressure treatments were conducted in a large HP system. This system was designed to operate according to the methods described in this patent. The vessel, the vessel lid, the sample holder, and the press liquid were all conditioned to 90° C. The pouches containing the spore suspensions were preheated for 5 min at 90° C. After the vessel was closed, pressure was first increased to 100 MPa in about 0.1 min. and subsequently to 700 MPa end-pressure in 0.3 min. Hold time at this pressure was 2.5 min. Release of pressure was about 10 s. In this example, the efficacy of a treatment of 1 pressure pulse was compared to a treatment consisting of 2 pressure pulses with a pause of 1 minute.

Spores in the untreated spore suspensions and surviving spores in the treated pouches that initially contained 5.0·10⁷ spores·ml⁻¹ were enumerated by pour plating in tryptone soy agar (TSA). Serial tenfold dilutions were made in a solution containing 0.9% (w/v) of sodium chloride and 0.1% (w/v) of peptone. Per plate 1 ml of inoculum was used. After 5 days of incubation at 37° C., colonies were counted and the viable count was calculated. The detection limit of this analysis was 10 CFU·ml⁻¹. This corresponded to 10 CFU on the plate inoculated with the undiluted spore suspension. The other treated pouches were stored at 37° C. After 30 days of storage, the pouches were visually evaluated for growth. From the pattern of occurrence and absence of growth in the pouches (2 to 3 replicates per spore concentration) the number of surviving spores was estimated by the most probable number method (MPN), a statistical approach for the enumeration of microorganisms in serial dilutions, according to the guidelines set forth by the FDA.

Results are presented in Table 11. Both the double pulse treatment and the single pulse treatment reduced the number of viable spores to a level below the detection limit of the plate count method (10 spores per ml). The most probable numbers of surviving spores of both treatments, as determined after a storage period of 30 days, were in agreement with the plate counts. So, there was no indication for recovery of spores during storage. No statistically significant difference was found be in the most probable number of surviving spores of the single and double pulse treatment. It was concluded that the single pulse treatment was as effective as the double pulse treatment.

TABLE 11

| | | | Result | | | | | |
|---|---|---|---|---|---|---|---|---|
| | | | | | | MPN and 95% R | | |
| Treatment | | | Viable count | | | confidence limit | | |
| Initial | Final | | (CFU · ml⁻¹) | | | (number · ml⁻¹) | | |
| T₀ | p | Number | Before | After | Decimal | | Lower | Upper |
| (° C.) | (MPa) | of pulses | treatment | treatment | reduction | MPN | limit | limit |
| 90 | 700 | 1 | 5.0 · 10⁷ | <10 | >6.7 | 1.5 | 0.18 | 13 |
| 90 | 700 | 2 | 5.0 · 10⁷ | <10 | >6.7 | <1 | 0 | 3.1 |

To demonstrate the effect of the methods described in this patent some numerical simulations have been performed. The methodology to perform these simulations consists of two parts. First the temperature distribution at any given product fraction at every time step is calculated using a Finite Element Model (FEM). In a second step the inactivation as function of time is calculated both at the center and at the wall of the product using a kinetic model. With this approach the authors clearly distinguish the relation between the ‘machinery’ and the process cycle on one hand and the kinetics (these are system properties independent of the machinery or process cycle) of the biochemical process on the other hand. The net effect of the pressure treatment is the net result of both.

The model constructed consists of an axi-symmetric one-dimensional FEM of the HPP system based on heat conduction through all relevant ‘layers’. Hence, it is a model that can be used to predict the temperature at any given position at any given time. One may argue that convection might be important resulting in a smaller temperature gradient. In practice, however convection hardly occurs since viscosity of liquid product increases (exponential) with increasing pressure. Another argument is related to the use of small consumer packages filled with liquid product, since these generally will not ‘move’ from their position. If solid products are pressurized the only heat transfer mechanism is by means of conduction. The FEM model consists of four layers: the HPP vessel wall, a liner material, a product container and the product itself. Both the thickness and the material properties (density, specific heat, adiabatic temperature rise, and heat conductivity) can be adjusted within this model.

Spore inactivation kinetics at combined elevated pressures and elevated temperatures are rarely found in literature. Especially treatments with pressures above 400 MPa and temperatures above 60° C. can only be found occasionally. In literature the experimental conditions are not described in great detail, hence, its hard to determine whether a homogeneous temperature distribution has been obtained during experimentation. Out of these inactivation experiments it is not possible to determine the actual inactivation kinetics. The kinetics describe the me of change of a biochemical process, which is a property of the biochemical system and therefore independent of the equipment used to determine the kinetics. The authors performed controlled experiments (with homogeneous temperature distribution) to determine the kinetics of Bacillus stearothermophilus spores (range 60-122° C. and 450-950° C.).

The combination of the FEM model and the obtained kinetics of Bacillus stearothermophilus is used as a simulation tool to perform two numerical experiments (Example 5 and Example 6):

### Example 5

Conventional HPP system at 90° C., product preheated to 90° C., 2 pulses of 700 MPa, holding time of each pulse 60 s

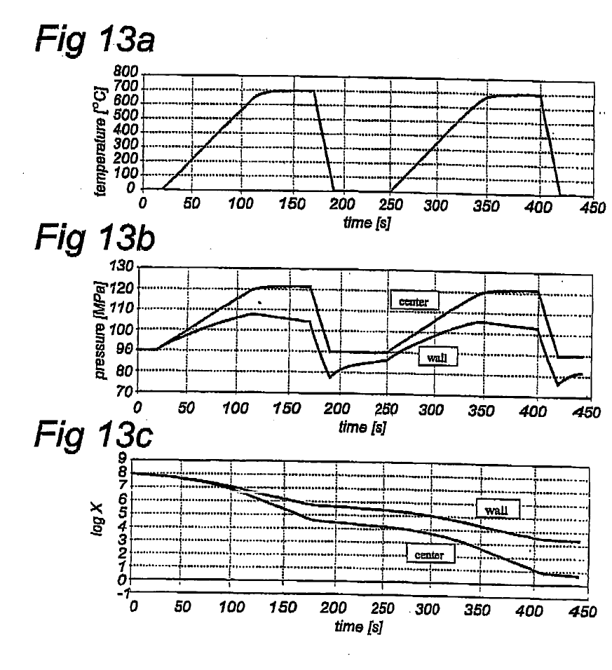

result: minimal decimal reduction; 4.7 (FIG. 13)

vs

System according to this invention at 105° C., product preheated to 90° C., 1 pulse of 700 MPa, holding time 150 s

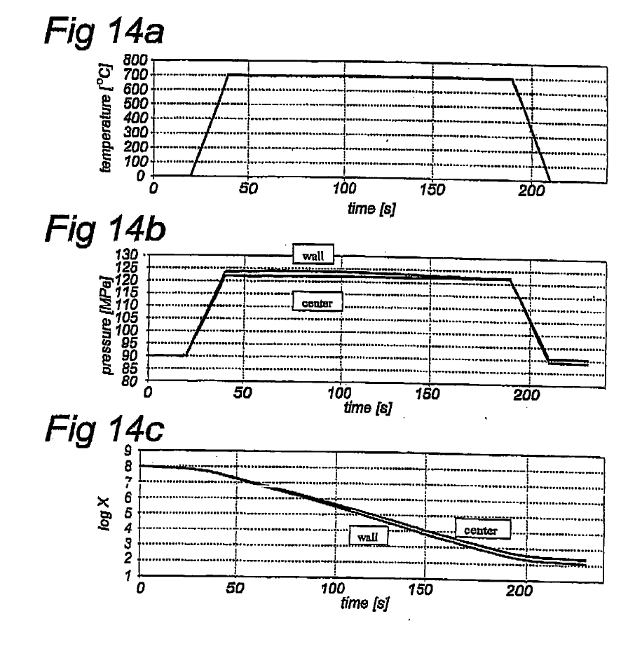

result; minimal decimal reduction: 5.6 (FIG. 14)

### Example 6

The same predictive model as described in Example 5 is applied to demonstrate the effectiveness of one pressure pulse using this invention:

Conventional HPP system at 90° C., product preheated to 90° C., 1 pulse of 700 MPa, holding time 300 s

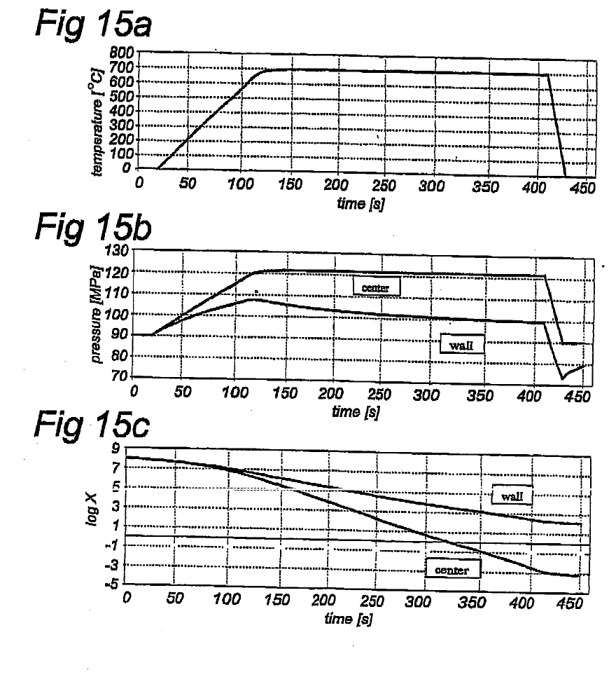

result: minimal decimal reduction: 5.6 (FIG. 15)

vs

System according to this invention at 105° C., product preheated to 90° C., 1 pulse of 700 MPa, holding time 150 s

result: minimal decimal reduction: 5.6 (FIG. 14)

FIGS. 1 to 10 are a graphical representation of a time-temperature-pressure relation of a high-pressure process in an HPP-system. The vertical axis below represents the pressure and the upper vertical axis represents temperature. The horizontal axis represents time. The thick line represents the temperature in the center of the HPP-vessel. The normal line represents the temperature inside the HPP-vessel of the product faction with the lowest temperatures. The thin line represents the vessel-temperature. As can be seen, in some cases a wide variety of product temperatures do occur (the shaded areas between the thick line and the normal line).

FIG. 1 is a graphical representation of a time-temperature-pressure relation of a high-pressure process in a typical commercial HPP-system. A wide variety of product temperatures do occur (shaded areas), a non-homogeneous product temperature distribution is obtained.

FIG. 2 is a graphic representation of a time-temperature-pressure relation of a high-pressure process in a system in which the methods of this invention are applied. The product temperatures vary within a narrow band, a homogeneous product temperature distribution is obtained.

FIG. 3 is a graphical representation of a time-temperature-pressure relation of a high-pressure process in a typical commercial HPP system as in FIG. 1, but with the vessel-temperature increased. A wide variety of product temperatures do occur (shaded areas), the product heats up very quickly, reducing product quality.

FIG. 4 is a graphical representation of a time-temperature-pressure relation of a high-pressure process of this invention with only one pulse and along pressure holding time. The product temperatures vary within a relatively narrow band, the temperature of the product fraction near the wall decreases only slightly even after the long pressure holding time; the temperature of the product faction near the wall could even be more constant if the vessel-temperature would be increased (refer to FIGS. 7 and 8).

FIG. 5 is a graphical representation of a time-temperate-pressure relation of a high-pressure process in a system with fast pressurization but without an inner HPP vessel material with low heat transfer properties. This system performs substantially better than the system in FIG. 1.

FIG. 6 is a graphical representation of a time-temperature-pressure relation of a high-pressure process in a system with an inner HPP vessel material with low heat transfer properties, but without fast pressurization. The product temperatures vary within a relatively narrow band, a product temperature distribution that is relatively homogeneous is obtained.

FIG. 7 is a graphical representation of a time-temperature-pressure relation of a high-pressure process according to this invention where an elevated vessel-temperature is used. The outer vessel material has a low the transfer coefficient. No overheating of the product is observed before the pressure is applied, the temperature distribution is homogeneous during the complete cycle.

FIG. 8 is a graphical representation of a time-temperature-pressure relation of a high-pressure process according to this invention where an elevated vessel-temperature is used. The outer vessel material has a high heat transfer coefficient (for instance the outer vessel part is constructed from steel). Again, no overheat of the product is observed before the pressure is applied, the temperature distribution is quite homogeneous during the complete cycle.

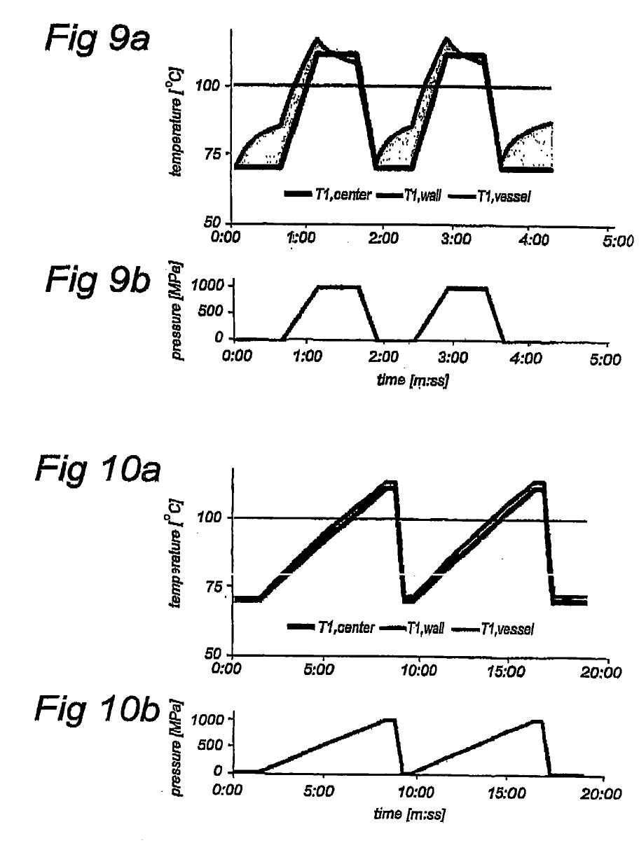

FIG. 9 is a graphical representation of a time-temperature-pressure relation of a high-pressure process in a system with fast pressurization, an elevated vessel-temperature, but no inner HPP vessel material with low heat transfer properties. A relatively wide variety of product temperatures do occur (shaded areas), the product heats up very quickly, reducing product quality.

FIG. 10 is a graphical representation of a time-temperature-pressure relation of a high pressure process in a system with slow pressurization, an elevated vessel-temperature, and an inner HPP vessel material with low heat temperature. Again, no substantial overheating of the product is observed before the pressure is applied, the temperature distribution is quite homogeneous during the complete cycle, although not as good as in FIGS. 7 and 8.

FIG. 11 represents a system according to this invention having a yoke 10, an intensifier 11, a vessel 12 and liner 13. Fast pressurization is achieved with the internal intensifier system; no additional unheated pressure liquid has to be added; the vessel walls, bottom and plunger are insulates and consist of a material with an adiabatic-temperature-rise that is similar to the adiabatic-temperature-rise of the food product. The solution proposed in this drawing is only one of several possible configurations that use the methods of this invention. The method of the invention can in particular be carried out using the light weight fiber-reinforced pressure vessel as described in European patent application no, EP 96203187.8 in the name of the applicant A particularly suitable fiber-reinforced high pressure vessel having an internal intensifier system and an axial loading arrangement of the pressure vessel is described in detail in International patent application WO 99/61146, in the name of the applicant. Both documents are incorporated herein by reference.

FIGS. 12a-12c schematically represents the operation of a system according to this invention having a lid 15 with a fast pre-fill opening 16. As posed clearly inside this patent the factor time is very import for both the costs and the product quality. In this figure three time steps within a pressure cycle are presented: FIG. 12a: the vessel is open and the plunger 14 does not touch the vessel wall. The vessel is filled with pressure liquid, by injecting this pressure liquid fast through pressure tubes with a very large diameter. This system is called fist pre-fill, FIG. 12b: the vessel is closed with the lid 15 (internal intensifier) and the plunger 14, liner 13 sealing system closed the vessel, hence it can be pressurized by driving the plunger inside the vessel. FIG. 12c: the system is closed and pressurized.

FIG. 13 is a graphical representation of a time-temperature-pressure-inactivation relation of a high pressure process in a conventional system; the upper part the figure represents the pressure inside the vessel as function of time; the middle part of the figure represents the temperature as function of time, both for the center of the vessel and at the vessel wall; the lower part of the figure represents the inactivation of Bacillus stearothermophilus as function of time. The temperature (middle part of hew figure) have been calculated using the axi-symmetric FEM model; the inactivation of Bacillus stearothermophilus (lower part of the figure) is calculated as function of the temperatures and pressure determined in the upper and middle part of the figure, using the kinetics determined by the authors. The pressure cycle consists of 2 pressure pulses of 700 MPa, with a pressurization time of 90 s and a holding time of 60 s (for each pulse). The vessel-temperature is at 90° C., the product is preheated to at initial-product-temperature of 90° C. At the end of the pressure cycle, the temperature at the vessel wall is 18° C. lower than in the center of the vessel. The inactivation is 4.7 D at the vessel wall.

FIG. 14 is a graphical representation of a time-temperature-pressure-inactivation relation of a high pressure process in a system according to this invention. The pressure cycle consists of 1 pressure pulse of 700 MPa, with a pressurization time of 20 s and a holding time of 150 s. The vessel-temperature is at 105° C., the product is preheated to an initial-product-temperature of 90° C. At the end of the pressure cycle, the temperature at the vessel wall is equal to the temperature in the center of the vessel. The inactivation is 5.6 D at the vessel wall, although the duration of the cycle is only half of the duration of the cycle of FIG. 13. And

FIG. 15 is a graphical representation of a time-temperature-pressure-inactivation relation of a high pressure process in a conventional system. The pressure cycle consists of 1 pressure pulse of 700 MPa, with a pressurization time of 90 s and a holding time of 300 s. The vessel-temperature is at 90° C., the product is preheated to an initial-product-temperature of 90° C. At the end of the pressure cycle, the temperature at the vessel wall is 22° C. lower than in the center of the vessel. The inactivation is 5.6 D at the vessel wall.

1. Method for treatment of a product, in particular preservation of a food product or pharmaceutical product, by use of high pressure, characterized that the high pressure process is carried out under such conditions that leakage of heat from the product to the surrounding material is minimized or even prevented.

2. Method according to claim 1, of high pressure treatment of a product, in particular preservation of a food product or treatment of a pharmaceutical product, in a pressure vessel, comprising pressurizing the product to a pressure of at least 100 MPa, preferably at least 300 MPa, most preferably at least 600 MPa characterized in that the pressure rate is at least 5 MPa·s⁻¹.

3. Method according to claim 2, wherein the pressure rate is at least 10 MPa·s⁻¹, preferably 20 MPa·s⁻¹, more preferably 30 MPa·s⁻¹.

4. Method according to claim 2 or 3, wherein a pressure vessel having an insulating wall is used, the wall having a heat conductivity no higher than 25 W·m⁻¹·K⁻¹, preferably not higher than 10 W·m⁻¹·K⁻¹, most preferably not higher than 1 W·m⁻¹·K⁻¹.

5. Method according to claim 1, of high pressure treatment of a product, in particular preservation of a food product or treatment of a pharmaceutical product, in a pressure vessel, comprising press the product to a pressure of at least 100 MPa, preferably at least 300 MPa, most preferably at least 600 MPa, the pressure vessel having an insulating wall having a heat conductivity no higher than 25 W·m⁻¹·K⁻¹, preferably not higher than 10 W·m⁻¹·K⁻¹ most preferably not higher then 1 W·m⁻¹·K⁻¹.

6. Method according to claims 1 to 5, wherein the pressure vessel comprises a liner having an adiabatic temperature rise of between 1 and 10 K per 100 MPa, preferably between 2 and 7 K per 100 MPa.

7. Method according to claim 1, of high pressure treatment of a product, in particular preservation of a food product or treatment of a pharmaceutical product, in a pressure vessel, comprising pressurizing the product to a pressure of at least 100 MPa, preferably at least 300 MPa, most preferably at least 600 MPa, wherein the pressure vessel comprises a liner having an adiabatic temperature rise of between 1 and 10 K per 100 MPa, preferably between 2 and 7 K per 100 MPa.

8. Method according to any of the preceding claims, using a pressurizing fluid which is at least of the same temperature as the product in the high pressure vessel.

9. Method according to any of the preceding claims, wherein the fluid used to pressurize the pressure system has an adiabatic temperature rise similar or higher than the adiabatic temperature rise of the product.

10. Method of high pressure treatment of a product, in particular preservation of a food product or treatment of a pharmaceutical product, in a pressure vessel comprising pressurizing the product to a pressure of at least 100 MPa, preferably at least 300 MPa, most preferably at least 600 MPa, using a pressurizing fluid having a temperature which is during the full pressure cycle not lower than 10° C. below the temperature of the product, preferably at least the same temperature as the product in the high pressure vessel.

11. Method according to any of the preceding claims, wherein under high pressure:
a) the temperature of the product and the surface temperature of a material surrounding the product are the same; or
b) the surface temperature is higher than the product temperature; or
c) the surface temperature is at most 10° C., more preferred at most 5° C. lower than the product temperature.

12. Method according to any of the preceding claims, wherein the total time of high pressure during treatment is smaller than 10 minutes, preferably smaller than 5 minutes, most preferably smaller than 1 minute.

13. Method according to any of the preceding claims, wherein the depressurization rate is at least 30 MPa·s⁻¹.

14. Method for treatment according to any of the preceding claims, wherein the product is held in a container made from a material, showing a temperature rise caused by high pressure treatment, which is at least similar, preferably higher, than the temperature rise of the product.

15. Method for treatment according to claim 14, wherein the container is made of a flexible material.

16. Method according to claim 14 or 15, wherein the container has a wall with a thickness of at least 2 mm, preferably from 3 to 20 mm, more preferably 4 to 10 mm.

17. Method for treatment according to any of claims 16-18, wherein the container is made of a material selected from the group comprising polyvinylchloride, polyoxymethylene, or polyethyleen.

18. Method of sterilising a product, according to any of the preceding claims, wherein an initial preheating of the product is applied of at least 60° C., whereafter the product is pressurised at least once at a pressure of at least 700 MPa for a total holding time at working pressure between 1 s and 600 s, more preferably between 5 s and 300 s, most preferably between 10 s and 200 s.

19. Method of sterilising a product, according to any of claims 1-17, wherein an initial preheating of the product is applied of at least 80° C., whereafter the product is pressurised at least once at a pressure of at least 500 MPa for a total holding time at working pressure between 1 s and 600 s, more preferably between 5 s and 300 s, most preferably between 10 s and 200 s.

20. Method according to claim 15 or 19, wherein the vessel has a temperature which is at least 10° C. higher than the tempera of the preheated product.

21. Method according to any of claims 18 to 20, wherein only a single pressure pulse is applied to the product.

22. Method of sterilising a product, wherein an initial preheating of the product is applied of at least 60° C., whereafter the product is pressurised once at a pressure of at least 500 MPa for a total holding time at working pressure between 1 s and 600 s, more preferably between 5 s and 300 s, most preferably between 10 s and 200 s, and wherein the vessel has a temperature of at least the temperature of the preheated product, more preferably 10° C. greater than the preheated product.

23. Method according to any of the preceding claims, using a pressure vessel comprising tangentially wound reinforcing fibres.

24. Method of high pressure treatment according to claims 2 and 5.

25. Method of high pressure treatment according to claims 5 and 7.

26. Method of high pressure treatment according to claims 2, 5 and 7.

27. Apparatus for carrying out the method according to any of claims 1-26, the apparatus comprising pressurisation means for exerting pressure on a product in a pressure vessel, wherein the pressurisation means are adapted to exert a pressure of at least 100 MPa, preferably at least 300 MPa, most preferably at least 600 MPa, at pressure rates of at least 5 MPa·s⁻¹.

28. Apparatus according to claim 27, wherein the pressure rate is at least 10 MPa·s⁻¹, preferably 20 MPa·s⁻¹, more preferably 30 MPa·s⁻¹.

29. Apparatus for carrying out the method according to any of claims 1-26, the apparatus comprising pressurisation means for exerting pressure on a product in a pressure vessel, wherein the pressurisation means are adapted to exert a pressure of at least 100 MPa, preferably at least 300 MPa, most preferably at least 600 MPa, at least the inner part of the pressure vessel, and/or a product container comprising the product, having a heat conductivity no higher than 25 W·m⁻¹·K⁻¹, preferably not higher than 10 W·m⁻¹·K⁻¹, most preferably not higher than 1 W·m⁻¹·K⁻¹.

30. Apparatus for carrying out the method according to any of claims 1-26, the apparatus comprising pressurisation means for exerting pressure on a product in a pressure vessel, wherein the pressurisation means are adapted to exert a pressure of at least 100 MPa, preferably at least 300 MPa, most preferably at least 600 MPa, at least the inner part of the pressure vessel, and/or the product container comprising the product, having an adiabatic temperature rise of between 1 and 10 K per 100 MPa, preferably between 2 and 7 K per 100 MPa.
